(19) United States
(12) Patent Application Publication
(10) Pub. No.: US 2012/0210930 A1
(43) Pub. Date: Aug. 23, 2012

(54) Multi-Flag, Vehicle Mounted Flag Pole with Handle

(76) Inventor: David B. Lupoff, Chatsworth, CA (US)

(21) Appl. No.: 13/253,800

(22) Filed: Oct. 5, 2011

Related U.S. Application Data
(60) Provisional application No. 61/444,082, filed on Feb. 17, 2011.

(51) Int. Cl. G09F 17/00

(52) U.S. Cl. 116/173

(57) ABSTRACT

A vehicle mounted flag pole is provided. The vehicle mounted flag pole comprises a pole, one or more flag stoppers, a handle, and a base. The one or more flag stoppers are provided on the pole so as to divide the pole into a plurality of sections for flags. The handle is provided at an end of the pole and defined by one or two grip stoppers. The base is disposed at an end of the handle and configured to attach the vehicle mounted flag pole detachably to a window of the vehicle.

### RELATED APPLICATION

This application is a non-provisional application for the provisional application Serial No. 61,444,082 for “Vehicle mounted flag pole” filed on Feb. 17, 2011.

### BACKGROUND OF THE INVENTION

The present invention relates to a vehicle mounted flag pole with a handle.

Many people want to display flags on their car. There have been suggested some conventional flag poles. However, they have problems in installing, maintaining, and using.

Accordingly, a need for a vehicle mounted flag pole with a handle has been present for a long time considering the expansive demands in the everyday life. This invention is directed to solve these problems and satisfy the long-felt need.

### SUMMARY OF THE INVENTION

The present invention contrives to solve the disadvantages of the prior art.

An object of the invention is to provide a vehicle mounted flag pole with a handle.

Another object of the invention is to provide a vehicle mounted flag pole with a handle, which is easy to install and use on a vehicle.

Still another object of the invention is to provide a vehicle mounted flag pole with a handle, which can be used for more than one purpose.

An aspect of the invention provides a vehicle mounted flag pole.

The vehicle mounted flag pole comprises a pole, one or more flag stoppers, a handle, and a base.

The one or more flag stoppers are provided on the pole so as to divide the pole into a plurality of sections for flags.

The handle is provided at an end of the pole and defined by one or two grip stoppers.

The base is disposed at an end of the handle and

Configured to attach the vehicle mounted flag pole detachably to a window of the vehicle.

Each of the flag stoppers may have a protrusion for keeping the flag in place in a section.

The protrusion may have a cylinderical shape.

The flag stoppers may be integrated with the pole.

The base may comprise a clip portion extending with a predetermined angle from between the pole and the window for attaching the vehicle mounted flag pole to the window.

The pole, the one or more flag stoppers, the handle, the one or two grip stoppers, and the base may be integrated into a body.

The pole, the one or more flag stoppers, the handle, and the one or two grip stoppers may be integrated into a first body, and the base may be provided as a second body that is configured to be attached to the first body.

Each of the one or more flag stoppers may be detachable.

The pole may comprise a plurality of sub-poles, which are configured to be connected and disconnected with mechanical fasteners.

Each of the mechanical fasteners may comprise a male thread and a female thread.

The advantages of the present invention are: (1) the vehicle mounted flag pole is convenient to install on a car; and (2) the vehicle mounted flag pole provides a handle with it for convenience of the user of the flag pole.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a perspective view of a vehicle mounted flag pole with a handle according to an embodiment of the invention having two flags displayed;

FIG. 2 is another perspective view of the vehicle mounted flag pole with handle of FIG. 1;

FIG. 3 is a partial perspective view of a handle portion of the vehicle mounted flag pole with handle of FIG. 2;

FIG. 4 is a side plan view showing a vehicle mounted flag pole with a handle according to another embodiment of the invention, in which a stopper removed for a detailed description;

FIG. 5 is a perspective view of a sub-pole connection according to an embodiment of the invention; and

FIG. 6 is a perspective view of a flag according to the invention.

### DETAILED DESCRIPTION EMBODIMENTS OF THE INVENTION

A vehicle mounted flag pole comprises a grip on it, which makes it expressing a dual purpose.

A user may waive the flag during and event, and then if they want to, attach it to their car.

The vehicle mounted flag pole can be displayed with one, two, or more flags. The flag pole is provided with a grip, with which the user can wield the flags on the flag pole. The parts of flag and the hand may snap on to the base which holds the car to the window.

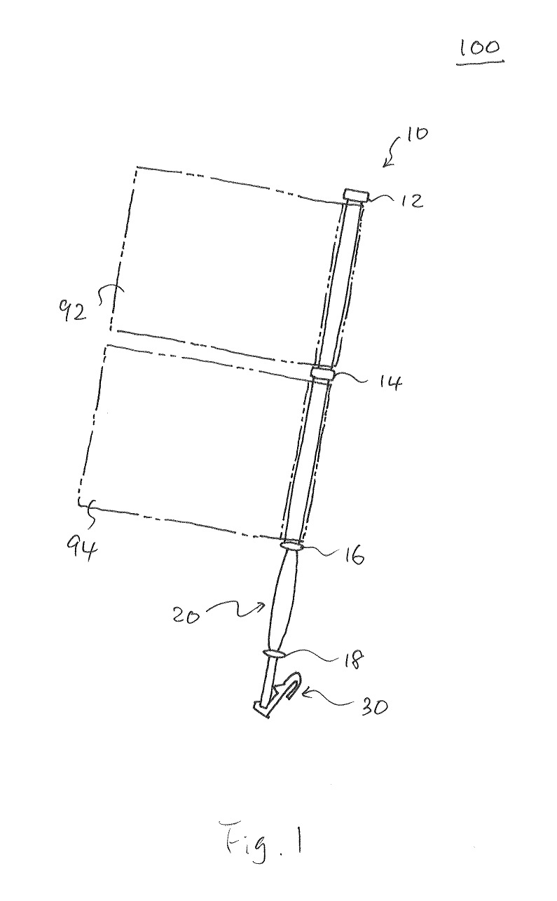

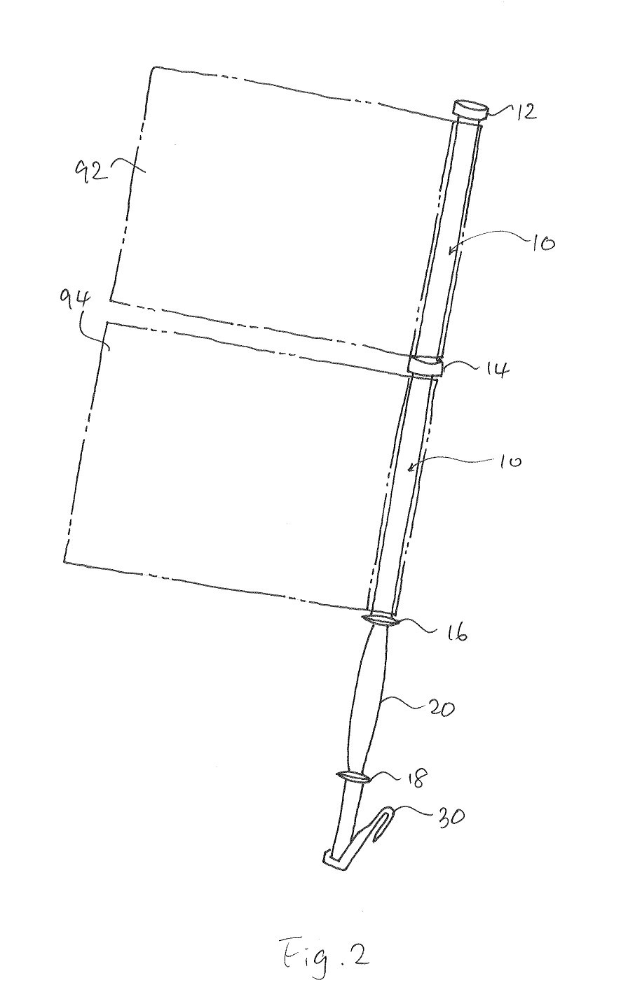

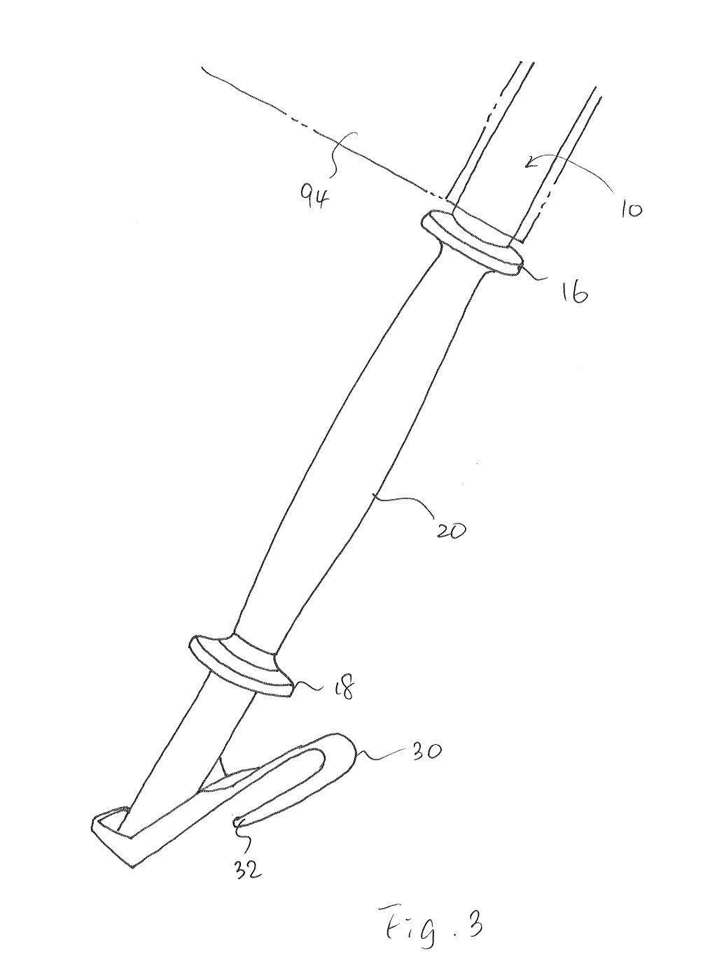

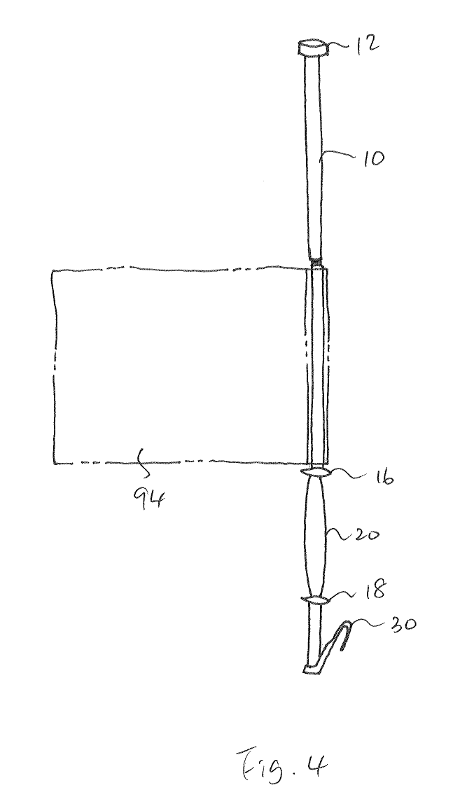

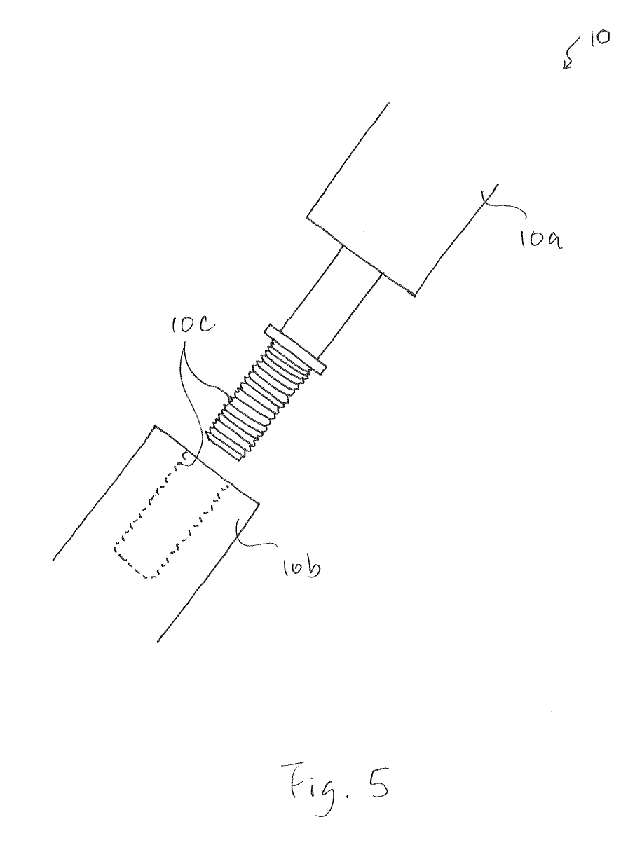

FIGS. 1-4 show a vehicle mounted flag pole according to an embodiment of the present invention. More specifically, FIG. 1 is a perspective view of a vehicle mounted flag pole with a handle according to an embodiment of the invention having two flags displayed. FIG. 2 is another perspective view of the vehicle mounted flag pole with handle of FIG. 1. FIG. 3 is a partial perspective view of a handle portion of the vehicle mounted flag pole with handle of FIG. 2. FIG. 4 is a side plan view showing a vehicle mounted flag pole with a handle according to another embodiment of the invention, in which a stopper removed for a detailed description. FIG. 5 is a perspective view of a sub-pole connection according to an embodiment of the invention.

According to another aspect of the invention, a multi-flag, car flag pole which supports more than one flag is provided, the flags can either be snapped on during the manufacturing or at the point of purchase by the consumer who will at the time of purchase have a choice of which flags he/she wishes to snap onto the pole. With the point of purchase option, the consumer will purchase the pole and the snaps separately from the flags themselves.

Attached, or molded onto the base (under the flags, above the window mount) of the multi-flag, car flag pole will be a handle that the consumer can use to show their support for their team, or player, etc. during the event itself. Therefore, this pole will have dual purposes.

First, for an attendee at an event to use to wave in support of their team, etc. (they'll hold the flag on the grip) and next to place onto their vehicle afterward.

A vehicle mounted flag pole comprises: a pole (10); one or more flag stoppers (12, 14) provided on the pole (10) so as to divide the pole (10) into a plurality of sections for flags; one or more grip stoppers (16, 18) provided on the pole (10); a handle (20) defined by the one or more grip stoppers (16, 18); and a base (30) disposed at an end of the handle (20) and configured to attach the flag pole (100) detachably to a window of the vehicle. The base (30) may include a clip portion which extends with a predetermined angle between the window and the pole (10). The clip portion is configured to hold to the window and still allow the window closed fully.

In an embodiment, the vehicle mounted flag pole (100) may be provided with all the components (10μ, 12, 14, 16, 18, 20, 30) integrated into one body.

In another embodiment, the pole (10), the one or more flag stoppers (12, 14), one or more grip stoppers (16, 18), the sections between the one or more flag stoppers (12, 14), and the handle (20) may be integrated into one body. The lower portion including the base (30) below the grip stopper (18) in FIG. 2 may be integrated into another body. And the two integrated bodies can engage each other just below the grip stopper (18). The engagement may be obtained by a mechanical fastener (not shown).

In still another embodiment, the one or more flag stoppers (12, 14) may be detachable as shown in FIG. 4.

In still another embodiment, the flag pole (100) may be configured to have the flags (94) installed in the sections defined by the one or more flag stoppers (12, 14) and the grip stopper (16). The flags (94) may be provided with a hook-and-loop seam for the purpose.

In still another embodiment, the flags (94) may be installed after the flag stoppers (12, 14) are disengaged from the pole (10).

In still another embodiment, the handle (20) may comprise a frictional surface adapted to be gripped easily. The frictional surface may comprise engraved patterns or letters, which may increase the surface friction of the handle (20) as in FIG. 3.

In still another embodiment, the flag pole (100) may comprise a plurality of sections which can be divided at the locations corresponding to the flag stoppers and the grip stoppers, as shown in FIGS. 4 and 5.

Another aspect of the invention provides a vehicle mounted flag pole (100).

The vehicle mounted flag pole (100) comprises a pole (10), one or more flag stoppers (12, 14), a handle (20), and a base (30) as shown in FIGS. 1-3.

The one or more flag stoppers (12, 14) are provided on the pole (10) so as to divide the pole (10) into a plurality of sections for flags. In the embodiment illustrated in FIG. 1, there are two sections in the pole (10). In certain embodiments, there can be only one section or more than two sections.

The handle (20) is provided at a lower end of the pole (10) and defined by one or two grip stoppers (16, 18). The one or two grip stoppers (16, 18) help the user of the flag pole to grip the vehicle mounted flag pole (100).

The base (30) is disposed at an end of the handle (20) and configured to attach the vehicle mounted flag pole (100) detachably to a window (not shown) of the vehicle. The vehicle mounted flag pole (100) can be hooked over the top edge of the window from outside of the car. And, then the window to be raised against an upper frame of the car window to hold tight between the window and the upper frame.

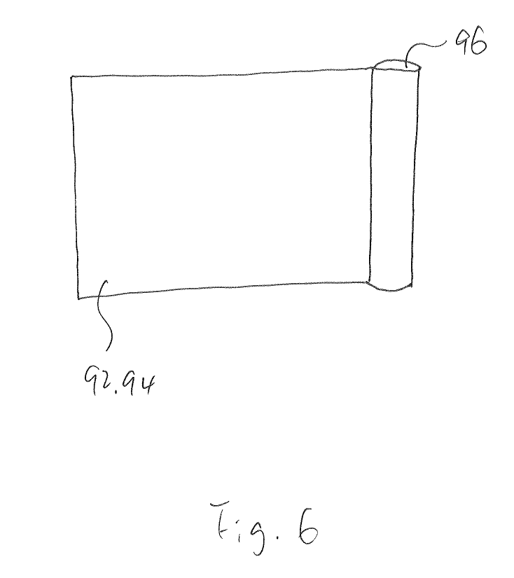

Each of the flag stoppers (12, 14) may have a protrusion for keeping the flag (92, 94) in place in a section. As shown in FIGS. 1-4, the flag (92, 94) may comprise a through edge hole (96) formed along an edge of the flag (92, 94). The pole (10) is queued through the through edge hole (96) as shown in FIG. 6.

The protrusion of the flag stoppers (12, 14) may have a cylinderical shape, but not limited to it. In certain embodiments of the invention, the protrusion may have other shapes such as triangle, rectangle, pentagon, etc.

The flag stoppers (12, 14) may be integrated with the pole (10). They can be molded as a single body.

The base (30) may comprise a clip portion (32) extending with a predetermined angle from between the pole (10) and the window for attaching the vehicle mounted flag pole (100) to the window as shown in FIG. 3. The window of the vehicle is inserted into the clip portion (32).

The pole (10), the one or more flag stoppers (12, 14), the handle (20), the one or two grip stoppers (16. 18), and the base (30) may be integrated into a body.

Alternatively, the pole (10), the one or more flag stoppers (12, 14), the handle (20), and the one or two grip stoppers (16, 18) may be integrated into a first body, and the base (30) may be provided as a second body that is configured to be attached to the first body detachably. The first and second bodies can be attached through one of conventional methods.

Each of the one or more flag stoppers (12, 14) may be detachable as shown in FIG. 4.

The pole (10) may comprise a plurality of sub-poles (10a, 10b), which are configured to be connected and disconnected with mechanical fasteners (10c) as shown in FIG. 5.

Each of the mechanical fasteners (10c) may comprise a male thread on a first sub-pole (10a) and a female thread in a second sub-pole (10b) as shown in FIG. 5.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed:

1. A vehicle mounted flag pole comprising:
a pole;
one or more flag stoppers provided on the pole so as to divide the pole into a plurality of sections for flags;
a handle provided at an end of the pole and defined by one or two grip stoppers; and
a base disposed at an end of the handle and configured to attach the vehicle mounted flag pole detachably to a window of the vehicle.

2. The vehicle mounted flag pole of claim 1, wherein each of the flag stoppers has a protrusion for keeping the flag in place in a section.

3. The vehicle mounted flag pole of claim 2, wherein the protrusion have a cylinderical shape.

4. The vehicle mounted flag pole of claim 2, wherein the flag stoppers are integrated with the pole.

5. The vehicle mounted flag pole of claim 1, wherein the base comprises a clip portion extending with a predetermined angle from between the pole and the window for attaching the vehicle mounted flag pole to the window.

6. The vehicle mounted flag pole of claim 5, wherein the pole, the one or more flag stoppers, the handle, the one or two grip stoppers, and the base are integrated into a body.

7. The vehicle mounted flag pole of claim 5, wherein the pole, the one or more flag stoppers, the handle, and the one or two grip stoppers are integrated into a first body, and the base is provided as a second body that is configured to be attached to the first body.

8. The vehicle mounted flag pole of claim 1, wherein each of the one or more flag stoppers is detachable.

9. The vehicle mounted flag pole of claim 1, wherein the pole comprises a plurality of sub-poles, which are configured to be connected and disconnected with mechanical fasteners.

10. The vehicle mounted flag pole of claim 9, wherein each of the mechanical fasteners comprise a male thread and a female thread.
